(19) United States
(12) Patent Application Publication
(10) Pub. No.: US 2026/0036373 A1
(43) Pub. Date: Feb. 5, 2026

(54) ADDITIVELY MANUFACTURED INTERWOVEN HEAT EXCHANGER WITH VARIABLE CHANNEL HEIGHTS

(71) Applicant: Hamilton Sundstrand Corporation, Charlotte, NC (US)

(72) Inventors: Jesse Ault, Chesterton, IN (US); David Saltzman, Glastonbury, CT (US); Grum T. Ngatu, South Windsor, CT (US); Tung Le, Enfield, CT (US); Mary J. Chenard, Enfield, CT (US)

(21) Appl. No.: 18/794,718

(22) Filed: Aug. 5, 2024

(51) Int. Cl. F28D 1/047; B33Y 80/00; F28F 1/02; F28F 1/08

(52) U.S. Cl. CPC F28D 1/0478; F28F 1/022; F28F 1/08; B33Y 80/00; F28F 2255/18

(57) ABSTRACT

A weave heat exchanger is provided. The weave heat exchanger includes tube layers and top and bottom sheets. Each tube layer includes first and second tubes extending in a first direction through which a first fluid is flowable. In each tube layer, each first tube has first waves repeating along the first direction and each second tube has second waves repeating along the first direction out-of-phase with the first waves. The first and second tubes in each tube layer form, together and with the first and second tubes of neighboring tube layers, voids extending in a second direction transverse to the first direction through which a second fluid is flowable. The top and bottom sheets are attached to top-most and bottom-most tube layers, respectively. Amplitudes of the first and second waves vary from middle tube layers to the top-most and bottom-most tube layer.

### BACKGROUND

The present disclosure relates to heat exchangers and, in particular, to additively manufactured interwoven heat exchangers with variable channel heights.

Heat exchangers aim to transfer heat between a hot fluid and a cool fluid. To increase the efficiency of heat exchangers, walls (primary surfaces) and fins (secondary surfaces) are utilized to increase the surface area through which thermal energy can transfer. The heat transfer through primary surface is very good because the walls are thin and the distance the thermal energy needs to travel is relatively small. The heat transfer through secondary surfaces is less efficient than primary surfaces because the thermal energy must travel a longer distance along the length of the fins. However, with conventional manufacturing techniques, the most compact heat exchangers (i.e., high surface area per unit volume) are achieved through increasing secondary surface area by adding fins rather than through the addition of primary surface area.

### SUMMARY

According to an aspect of the disclosure, a weave heat exchanger is provided. The weave heat exchanger includes tube layers and top and bottom sheets. Each tube layer includes first and second tubes extending in a first direction through which a first fluid is flowable. In each tube layer, each first tube has first waves repeating along the first direction and each second tube has second waves repeating along the first direction out-of-phase with the first waves. The first and second tubes in each tube layer form, together and with the first and second tubes of neighboring tube layers, voids extending in a second direction transverse to the first direction through which a second fluid is flowable. The top and bottom sheets are attached to top-most and bottom-most tube layers, respectively. Amplitudes of the first and second waves vary from middle tube layers to the top-most and bottom-most tube layer.

In accordance with additional or alternative embodiments, in each tube layer, the first and second waves are 180 degrees out-of-phase.

In accordance with additional or alternative embodiments, the top and bottom sheets are at least one of wavy and flat.

In accordance with additional or alternative embodiments, in each tube layer, wavelengths of the first and second waves vary with at least one of increasing wavelengths at inlet and outlet sides and straightened first and second tubes at the inlet and outlet sides.

In accordance with additional or alternative embodiments, the amplitudes of the first and second waves exhibit sine wave variance from middle tube layers to the top-most and bottom-most tube layers.

In accordance with additional or alternative embodiments, the amplitudes of the first and second waves are increased in the middle tube layers and decreased at the top-most and bottom-most tube layers.

In accordance with additional or alternative embodiments, the amplitudes of the first and second waves exhibit sine wave variance in multiple directions.

In accordance with additional or alternative embodiments, flow capacities of the first and second tubes vary from middle tube layers to the top-most and bottom-most tube layers.

In accordance with additional or alternative embodiments, a multi-pass weave heat exchanger is provided and includes the weave heat exchanger with multiple flow passes.

According to an aspect of the disclosure, a weave heat exchanger is provided and includes tube layers and top and bottom sheets. Each tube layer includes first and second tubes extending in a first direction through which a cold fluid is flowable. In each tube layer, each first tube has first waves repeating along the first direction and each second tube has second waves repeating along the first direction out-of-phase with the first waves. The first and second tubes in each tube layer form, together and with the first and second tubes of neighboring tube layers, voids extending in a second direction transverse to the first direction through which a hot fluid is flowable. The top and bottom sheets are attached to top-most and bottom-most tube layers, respectively. Amplitudes of the first and second waves vary from middle tube layers to the top-most and bottom-most tube layers.

In accordance with additional or alternative embodiments, in each tube layer, the first and second waves are 180 degrees out-of-phase.

In accordance with additional or alternative embodiments, the top and bottom sheets are at least one of wavy and flat.

In accordance with additional or alternative embodiments, in each tube layer, wavelengths of the first and second waves vary with at least one of increasing wavelengths at inlet and outlet sides and straightened first and second tubes at the inlet and outlet sides.

In accordance with additional or alternative embodiments, the amplitudes of the first and second waves exhibit sine wave variance from middle tube layers to the top-most and bottom-most tube layers.

In accordance with additional or alternative embodiments, the amplitudes of the first and second waves are increased in the middle tube layers and decreased at the top-most and bottom-most tube layers.

In accordance with additional or alternative embodiments, the amplitudes of the first and second waves exhibit sine wave variance in multiple directions.

In accordance with additional or alternative embodiments, flow capacities of the first and second tubes vary from middle tube layers to the top-most and bottom-most tube layers.

In accordance with additional or alternative embodiments, a multi-pass weave heat exchanger is provided and includes the weave heat exchanger with multiple flow passes.

According to an aspect of the disclosure, a weave heat exchanger additive manufacturing method is provided and includes forming a bottom sheet and building up tube layers on the bottom sheet. Each tube layer includes first and second tubes extending in a first direction through which a first fluid is flowable. In each tube layer, each first tube has first waves repeating along the first direction and each second tube has second waves repeating along the first direction out-of-phase with the first waves. The first and second tubes in each tube layer form, together and with the first and second tubes of neighboring tube layers, voids extending in a second direction transverse to the first direction through which a second fluid is flowable. The weave heat exchanger additive manufacturing method further includes forming a top sheet on a top-most tube layer and executing the building up such that first and second wave amplitudes vary from middle tube layers to the top-most and a bottom-most tube layer.

In accordance with additional or alternative embodiments, the executing of the building up such that first and second wave amplitudes vary includes modifying mathematical functions that define layer surfaces of the first and second tubes in each tube layer and applying correct transformations to each of the layer surfaces of the first and second tubes in each tube layer in accordance with the modifying of the mathematical functions.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIGS. 1A and 1B are perspective and side views of an additively manufactured weave heat exchanger with wavy top and bottom sheets in accordance with embodiments;

FIGS. 2A and 2B are perspective and side views of an additively manufactured weave heat exchanger with flat top and bottom sheets in accordance with embodiments;

FIG. 3 is a schematic side view of a portion of an additively manufactured weave heat exchanger with waves of varying wavelengths in accordance with embodiments;

FIG. 4 is a schematic side view of a portion of an additively manufactured weave heat exchanger with waves of varying wavelengths in accordance with embodiments;

FIG. 5 is a schematic side view of an additively manufactured weave heat exchanger with amplitude variance in accordance with embodiments;

FIG. 6 is a schematic side view of an additively manufactured weave heat exchanger with amplitude and tube height variance in accordance with embodiments;

FIG. 7 is a plan view of an additively manufactured weave heat exchanger with a rectangular cross-sectional shape in accordance with embodiments;

FIG. 8 is a plan view of an additively manufactured weave heat exchanger with an annular cross-sectional shape in accordance with embodiments;

FIG. 9 is a plan view of an additively manufactured weave heat exchanger with a ring-shaped cross-sectional shape in accordance with embodiments;

FIG. 10 is a schematic side view of an additively manufactured weave heat exchanger with amplitude and tube height variance and multiple flow path directions in accordance with embodiments; and

FIG. 11 is a flow diagram illustrating a method of additively manufacturing a weave heat exchanger in accordance with embodiments.

### DETAILED DESCRIPTION

Many technological fields, including aerospace, are interested in advanced heat exchangers as operating temperatures increase and as cooling requirements also increase. A weave heat exchanger design, for example, is an additively manufactured heat exchanger with an interwoven passage geometry in which discrete channels of two fluid circuits weave around each other to augment heat exchange and keep each fluid passage in constant contact with the flow path of the other fluid. While the weave heat exchanger design uses constant and uniform channel heights for all the layers of the heat exchanger, increased waviness of the channels can be desirable for more enhanced and/or augmented heat transfer. Such increased waviness tends to increase thermal stresses on heat exchanger walls, however, especially at the top and bottom layers where mounting locations are typically located. Furthermore, if the weave heat exchanger is mounted in a high vibration environment, such as in the frame of an aircraft, load paths through the mounts and end sheets can cause the material to yield and may lead to a failure. By reducing the waviness of the weave heat exchanger at the mounting location, a stronger and more robust core is formed.

Thus, as will be described below, a weave heat exchanger design is provided with a modified geometry. This modified geometry can be characterized as having variable channel heights, especially at top and bottom layers, with relatively high-amplitude wave channels in a bulk of a core and decreased waviness for outer layers of the core where thermal stresses can be problematic.

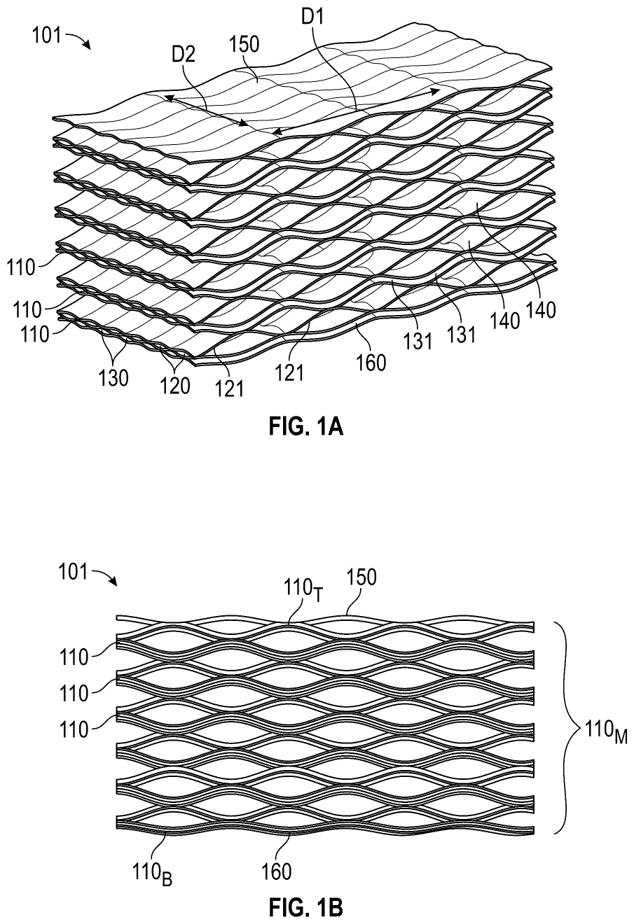

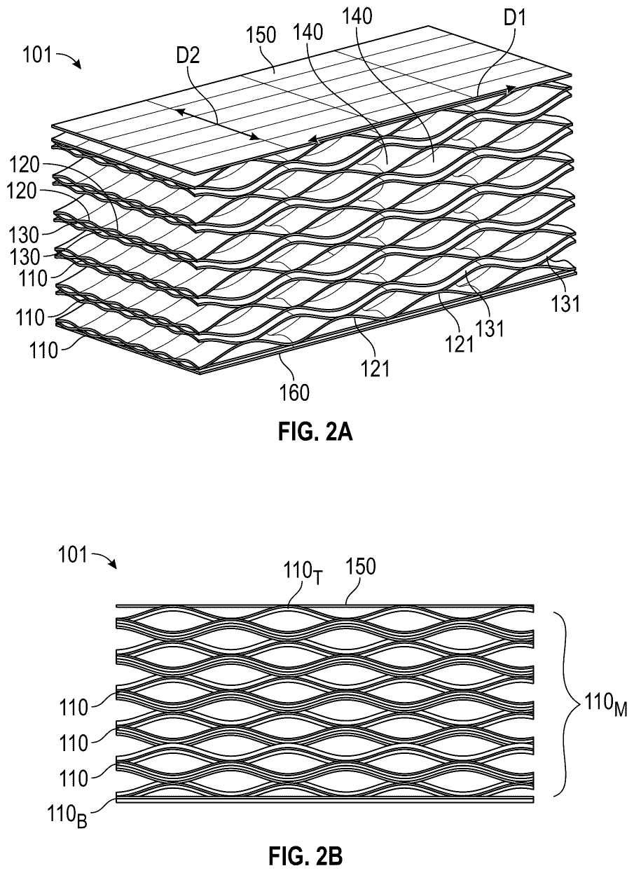

With reference to FIGS. 1A and 1B and to FIGS. 2A and 2B, a weave heat exchanger 101 is provided. The weave heat exchanger 101 includes multiple tube layers 110, a top sheet 150 and a bottom sheet 160. Each of the multiple tube layers 110 includes first tubes 120 extending in a first direction D1 and second tubes 130 extending in the first direction D1. A first fluid is flowable through the first tubes 120 and through the second tubes 130 in each of the multiple tube layers 110. In each of the multiple tube layers 110, each of the first tubes 120 has first waves 121 repeating along the first direction D1 and each of the second tubes 130 has second waves 131 repeating along the first direction D1 in an out-of-phase condition (i.e., about 180 degrees) with respect to the first waves 121. Also, the first tubes 120 and the second tubes 130 in each of the multiple tube layers 110 form flow voids 140 together with each other and with the first tubes 120 and the second tubes 130 of neighboring ones of the multiple tube layers 110. The flow voids 140 extend in a second direction D2, which is transverse or perpendicular to the first direction D1. A second fluid is flowable through the flow voids 140. The top sheet 150 is attached to the first tubes 120 or the second tubes 130 of a top-most tube layer 110 of the multiple tube layers 110. The bottom sheet 160 is attached to the first tubes 120 or the second tubes 130 of a bottom-most tube layer 110B of the multiple tube layers 110.

In accordance with embodiments, amplitudes of the first and second waves 121 and 131 can vary from middle tube layers to the top-most tube layer 110T and to the bottom-most tube layer 110B of the multiple tube layers 110. Thus, as shown in FIGS. 1A and 1B and in FIGS. 2A and 2B, amplitudes of the second waves 131 of the second tubes 130 of the top-most tube layer 110T and amplitudes of the first waves 121 of the first tubes 120 of the bottom-most tube layer 110B are reduced as compared to amplitudes of the first and second waves 121 and 131 of the first and second tubes 120 and 130 of other ones of the multiple tube layers 110 with the top sheet 150 and the bottom sheet 160 being wavy (see FIGS. 1A and 1B) or flat (see FIGS. 2A and 2B).

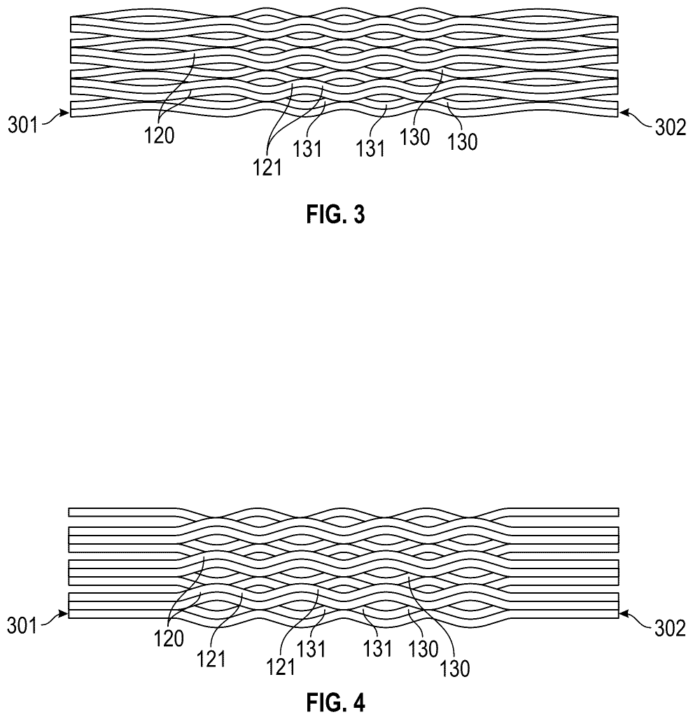

With continued reference to FIGS. 1A and 1B and to FIGS. 2A and 2B and with additional reference to FIGS. 3 and 4, in each of the multiple tube layers 110, wavelengths of the first waves 121 of the first tubes 120 and wavelengths of the second waves 131 of the second tubes 130 can vary. That is, as shown in FIG. 3, wavelengths of the first waves 121 of the first tubes 120 and wavelengths of the second waves 131 of the second tubes 130 can vary with increasing wavelengths at an inlet side 301 and at an outlet side 302 and, as shown in FIG. 4, with straightened first tubes 120 and straightened second tubes 130 at the inlet side 301 and at the outlet side 302.

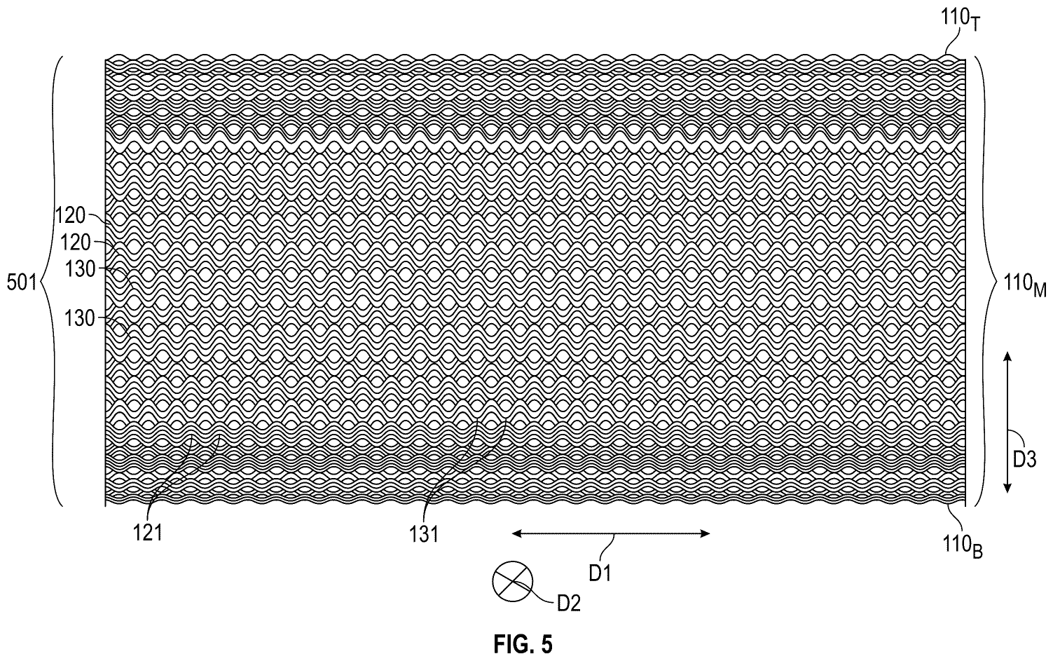

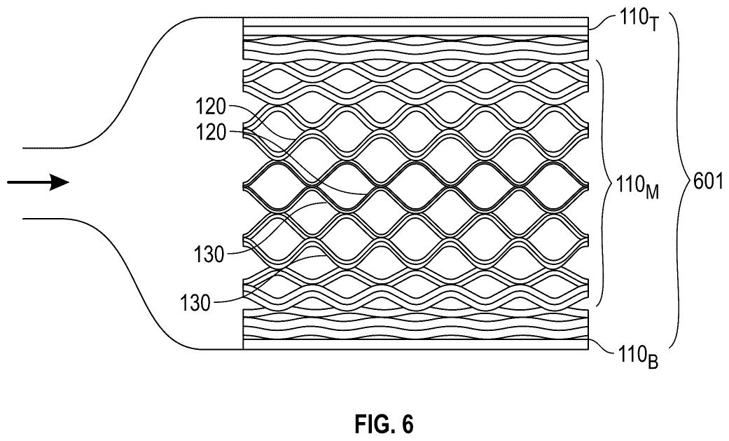

With continued reference to FIGS. 1A and 1B and to FIGS. 2A and 2B and with additional reference to FIGS. 5 and 6, the amplitudes of the first waves 121 of the first tubes 120 of the multiple tube layers 110 and amplitudes of the second waves 131 of the second tubes 130 of the multiple tube layers 110 can exhibit a sine wave variance 501 from middle tube layers 110M of the multiple tube layers 110 to the top-most tube layer 110T and to the bottom-most tube layer 110B. That is, in an exemplary case as shown in FIG. 5, the amplitudes of the first and second waves 121 and 131 are increased in the middle tube layers 110M and decreased at the top-most tube layer 110T and at the bottom-most tube layer 110B. Additionally, while the amplitudes of the first and second waves 121 and 131 exhibit the sine wave variance 501 in a third (or vertical) direction D3 in FIG. 5, it is to be understood that the amplitudes of the first and second waves 121 and 131 can exhibit the sine wave variance 501 in multiple directions (i.e., in two or more of the first direction D1, the second direction D2 and the third direction D3). Further, as shown in FIGS. 5 and 6, flow capacities of the first tubes 120 of the multiple tube layers 110 and flow capacities of the second tubes 130 of the multiple tube layers 110 can vary from the middle tube layers 110M to the top-most tube layer 110T and to the bottom-most tube layer 110B.

Regarding the embodiments shown in FIG. 6, decreasing heights and flow capacities of the first tubes 120 of the multiple tube layers 110M and decreasing heights and flow capacities of the second tubes 130 of the multiple tube layers 110M while maintaining high waviness can be employed to maintain heat transfer augmentation (i.e., tube height variance 601). This can also be used to increase a pressure drop through the first tubes 120 of the multiple tube layers 110M and through the second tubes 130 of the multiple tube layers 110M and to thereby encourage more flow through the outer and wider first and second tubes 120 and 130 (i.e., the top-most tube layer 110T and to the bottom-most tube layer 110B). This would in turn counteract the natural tendency of flows to prefer to flow through the first tubes 120 of the multiple tube layers 110M and the second tubes 130 of the multiple tube layers 110M in a typical converging header. In any case, having variable tube height amplitudes offers an additional design tool for adjusting/optimizing flow distribution in the weave heat exchanger 101.

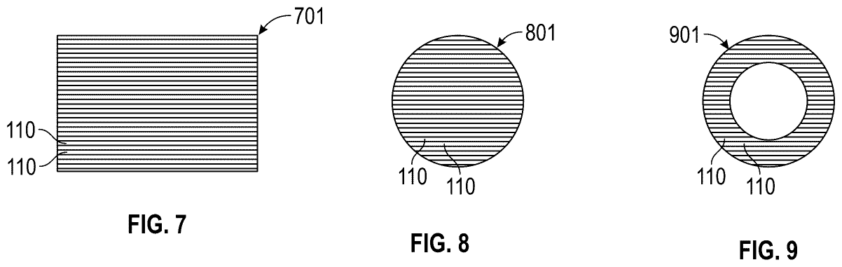

With reference to FIGS. 7, 8 and 9, the multiple tube layers 110 can be arranged to have a cross-sectional shape that is rectangular 701 (see FIGS. 1A and 2A and FIG. 7). However, it is to be understood that various other shapes are possible. These can include, but are not limited to, annular shapes 801 (see FIG. 8) and ring-shapes 901 (see FIG. 9).

The multiple tube layers 110 can be modified to have hot or cold layers as the top-most tube layer 110T and to the bottom-most tube layer 110B. For example, the top-most tube layer 110T can be a cold layer and the bottom-most tube layer 110B can be a hot layer. In some, but not all cases, the top-most tube layer 110T and the bottom-most tube layer 110B will be hot layers in order to balance out temperature gradients and to reduce thermal stresses.

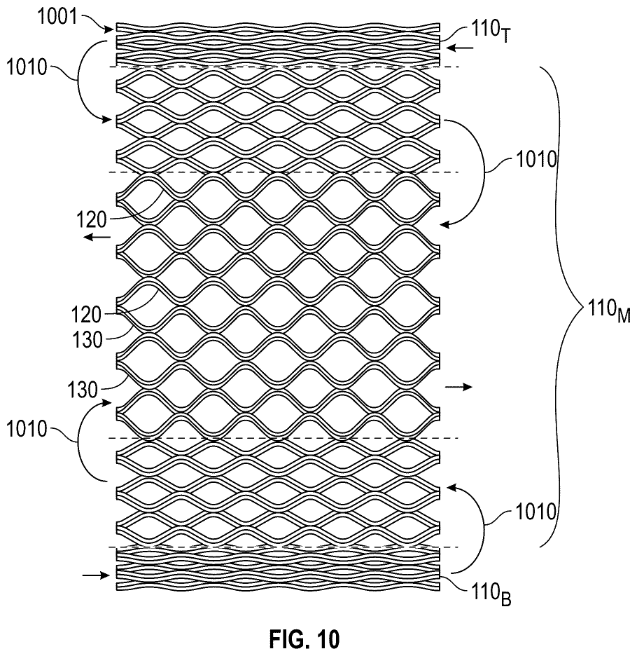

With reference to FIG. 10, the weave heat exchanger 101 can be configured as a multi-pass weave heat exchanger 1001 with multiple passes 1010 that uses different channel shapes/sizes for each pass. As shown in FIG. 10, the multi-pass weave heat exchanger 1001 includes similar features as described above including, in particular, the sine wave variance 501 of FIG. 5 and the tube height variance of FIG. 6.

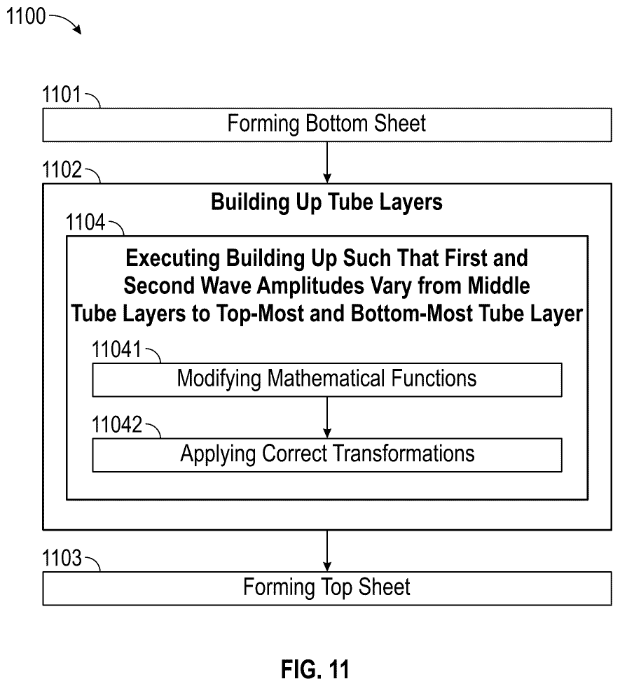

With reference to FIG. 11, a weave heat exchanger additive manufacturing method 1100 is provided. As shown in FIG. 11, the weave heat exchanger additive manufacturing method can include forming a bottom sheet (block 1101) by any suitable manufacturing process, building up tube layers on the bottom sheet (block 1102) by additive manufacturing (i.e., powder bed laser fusion) such that each tube layer includes first and second tubes extending in a first direction through which a first fluid is flowable, where, in each tube layer, each first tube has first waves repeating along the first direction and each second tube has second waves repeating along the first direction out-of-phase with the first waves, and where the first and second tubes in each tube layer form, together and with the first and second tubes of neighboring tube layers, voids extending in a second direction transverse to the first direction through which a second fluid is flowable. The weave heat exchanger additive manufacturing method can also include forming a top sheet on a top-most tube layer (block 1103) by any suitable manufacturing process. In addition, the weave heat exchanger additive manufacturing method can be characterized in that the building up of the tube layers includes executing the building up such that first and second wave amplitudes vary from middle tube layers to the top-most and a bottom-most tube layer (block 1104) where the executing of the building up of block 1104 includes modifying mathematical functions that define layer surfaces of the first and second tubes in each tube layer (block 11041) and applying correct transformations to each of the layer surfaces of the first and second tubes in each tube layer in accordance with the modifying of the mathematical functions (block 11042).

As used herein, the coincidental operations of layer build-up refers to the fact that, as each layer of the additively manufactured heat exchanger (i.e., the additively manufactured heat exchanger 101 described above) is laid down, that layer can include a corresponding portion of one or more of the first and second inlet and outlet headers, the core, the stiffening fins, the exterior structural reinforcements and the self-supporting core support structures. In this manner, additive manufacturing can provide for the build-up of complex structural geometries that are not otherwise possible with conventional processes, such as casting and machining.

Technical effects and benefits of the present disclosure are the provision of an additively manufactured weave heat exchanger with a best-of-both-worlds design characterized as having strongly wavy channels in the majority of the heat exchanger core and a transition to less wavy channels at the top and bottom layers to reduce the peak thermal stresses with improvements related to flow malformation in the top and bottom layers. This added flexibility in amplitude variance different layers of the weave heat exchanger allows for a blending of high-amplitude channels in the core of the weave heat exchanger, which are desirable for augmented heat transfer, with low-amplitude channels at the top and bottom of the weave heat exchanger, which are desirable for reduced thermal stresses. In addition, the weave heat exchanger geometry can be manufactured with additive manufacturing processes (i.e., 3D printing). The additive manufacturing processes allow for complex designs to be created with little added costs. Having the ability to truly optimize each fluids passage independently allows for the most optimal component design for a given set of constraints. Modifying the geometry definition in such a way as to allow variable layer amplitudes incorporates a new lever of control over the geometry, further opening up the design space, and likely opening up new opportunities for optimization.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A weave heat exchanger, comprising:
tube layers, each tube layer comprising first and second tubes extending in a first direction through which a first fluid is flowable,
in each tube layer, each first tube has first waves repeating along the first direction and each second tube has second waves repeating along the first direction out-of-phase with the first waves, and
the first and second tubes in each tube layer forming, together and with the first and second tubes of neighboring tube layers, voids extending in a second direction transverse to the first direction through which a second fluid is flowable; and
top and bottom sheets attached to top-most and bottom-most tube layers, respectively,
amplitudes of the first and second waves varying from middle tube layers to the top-most and bottom-most tube layers.

2. The weave heat exchanger according to claim 1, wherein, in each tube layer, the first and second waves are 180 degrees out-of-phase.

3. The weave heat exchanger according to claim 1, wherein the top and bottom sheets are at least one of wavy and flat.

4. The weave heat exchanger according to claim 1, wherein, in each tube layer, wavelengths of the first and second waves vary with at least one of increasing wavelengths at inlet and outlet sides and straightened first and second tubes at the inlet and outlet sides.

5. The weave heat exchanger according to claim 1, wherein the amplitudes of the first and second waves exhibit sine wave variance from middle tube layers to the top-most and bottom-most tube layers.

6. The weave heat exchanger according to claim 5, wherein the amplitudes of the first and second waves are increased in the middle tube layers and decreased at the top-most and bottom-most tube layers.

7. The weave heat exchanger according to claim 5, wherein the amplitudes of the first and second waves exhibit sine wave variance in multiple directions.

8. The weave heat exchanger according to claim 1, wherein flow capacities of the first and second tubes vary from middle tube layers to the top-most and bottom-most tube layers.

9. A multi-pass weave heat exchanger comprising the weave heat exchanger according to claim 1 with multiple flow passes.

10. A weave heat exchanger, comprising:
tube layers, each tube layer comprising first and second tubes extending in a first direction through which a cold fluid is flowable,
in each tube layer, each first tube has first waves repeating along the first direction and each second tube has second waves repeating along the first direction out-of-phase with the first waves, and
the first and second tubes in each tube layer forming, together and with the first and second tubes of neighboring tube layers, voids extending in a second direction transverse to the first direction through which a hot fluid is flowable; and
top and bottom sheets attached to top-most and bottom-most tube layers, respectively,
amplitudes of the first and second waves varying from middle tube layers to the top-most and bottom-most tube layers.

11. The weave heat exchanger according to claim 10, wherein, in each tube layer, the first and second waves are 180 degrees out-of-phase.

12. The weave heat exchanger according to claim 10, wherein the top and bottom sheets are at least one of wavy and flat.

13. The weave heat exchanger according to claim 10, wherein, in each tube layer, wavelengths of the first and second waves vary with at least one of increasing wavelengths at inlet and outlet sides and straightened first and second tubes at the inlet and outlet sides.

14. The weave heat exchanger according to claim 10, wherein the amplitudes of the first and second waves exhibit sine wave variance from middle tube layers to the top-most and bottom-most tube layers.

15. The weave heat exchanger according to claim 14, wherein the amplitudes of the first and second waves are increased in the middle tube layers and decreased at the top-most and bottom-most tube layers.

16. The weave heat exchanger according to claim 14, wherein the amplitudes of the first and second waves exhibit sine wave variance in multiple directions.

17. The weave heat exchanger according to claim 10, wherein flow capacities of the first and second tubes vary from middle tube layers to the top-most and bottom-most tube layers.

18. A multi-pass weave heat exchanger comprising the weave heat exchanger according to claim 10 with multiple flow passes.

19. A weave heat exchanger additive manufacturing method, comprising:
forming a bottom sheet;
building up tube layers on the bottom sheet, each tube layer comprising first and second tubes extending in a first direction through which a first fluid is flowable,
in each tube layer, each first tube has first waves repeating along the first direction and each second tube has second waves repeating along the first direction out-of-phase with the first waves, and
the first and second tubes in each tube layer forming, together and with the first and second tubes of neighboring tube layers, voids extending in a second direction transverse to the first direction through which a second fluid is flowable; and
forming a top sheet on a top-most tube layer,
executing the building up such that first and second wave amplitudes vary from middle tube layers to the top-most and a bottom-most tube layer.

20. The method according to claim 19, wherein the executing of the building up such that first and second wave amplitudes vary comprises:
modifying mathematical functions that define layer surfaces of the first and second tubes in each tube layer; and
applying correct transformations to each of the layer surfaces of the first and second tubes in each tube layer in accordance with the modifying of the mathematical functions.
